(19) United States
(12) Patent Application Publication
(10) Pub. No.: US 2022/0170557 A1
(43) Pub. Date: Jun. 2, 2022

(54) MOLDED PLUG CARTRIDGE WITH FLUOROPOLYMER

(71) Applicant: Xomox Corporation, Cincinnati, OH (US)

(72) Inventors: Sudhir K. KULKARNI, Mason, OH (US); Alain FUOC, Brunstatt (FR); László GAZDAG, Székesfehérvár (HU); Richard E. WALKER, Martinsville, OH (US); Tamás CSEHOVICS, Bakonykúti (HU)

(21) Appl. No.: 17/536,600

(22) Filed: Nov. 29, 2021

Related U.S. Application Data
(60) Provisional application No. 63/119,335, filed on Nov. 30, 2020.

(51) Int. Cl. F16K 5/02; F16K 27/06

(52) U.S. Cl. CPC F16K 5/025; F16K 5/0271; B29C 45/14336; F16K 27/062; F16K 5/0207

(57) ABSTRACT

A valve assembly includes a cartridge configured to be removably coupled to a valve body. The cartridge includes a hub. The valve assembly further includes a sleeve encapsulating at least a portion of the hub and having an internal sleeve surface defining an interior cavity.

### PRIORITY

This application claims the benefit of U.S. Pat. App. No. 63/119,335, entitled “Molded Plug Cartridge with Fluoropolymer,” filed Nov. 30, 2020, the disclosure of which is incorporated by reference herein.

### BACKGROUND

Some valves include a valve assembly and a main valve body for coupling with the valve assembly. The valve body may include a housing and at least one end connector element extending from the housing. The end connector element is used to secure a pipeline or similar feature to the valve via welding or fasteners. With regard to plug style valves, the valve assembly may include a mounting plate configured to be fixedly coupled to the housing and a plug rotatably extending from the mounting plate into an internal chamber of the housing. The plug includes a plug body configured to inhibit the flow of fluid through the plug when the plug is in a closed state and a plug flow passage extending through the plug body configured to facilitate the flow of fluid through the plug when the plug is in an open state.

Some plug style valves further include a sleeve fixedly secured within the internal chamber of the housing and having an interior cavity for rotatably receiving the plug as well as a pair of apertures for aligning with the plug flow passage when the plug is in the open state. The sleeve may be configured to provide a fluid-tight seal between the plug body and the housing and may be constructed of a polymeric material having a relatively high chemical resistance and a relatively low coefficient of friction, such as Polytetrafluoroethylene (PTFE). Such valves may be referred to as sleeved plug valves.

While certain sleeved plug valves have been made and used, it is believed that no one prior to the inventor(s) has made or used the invention described in the appended claims.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a perspective view of an exemplary sleeved plug valve;

FIG. 2 depicts an exploded perspective view of the sleeved plug valve of FIG. 1 with a valve body of the sleeved plug valve spaced apart from a valve assembly of the sleeved plug valve, the valve assembly having an exemplary plug spaced apart from an exemplary cartridge with an exemplary sleeve affixed thereto;

FIG. 3 depicts an exploded perspective view of the valve body of FIG. 2 with an exemplary pair of end connector elements spaced apart from an exemplary housing;

FIG. 4 depicts a partial exploded perspective view of the valve assembly of FIG. 2 with the sleeve spaced apart from a lower hub of the cartridge;

FIG. 5 depicts a cross-sectional view of the sleeve of FIG. 2;

FIG. 6 depicts a cross-sectional view of the plug of FIG. 2;

FIG. 7A depicts a cross-sectional view of the sleeved plug valve of FIG. 1 taken along section line 7A-7A in FIG. 1, with the plug in an open state;

FIG. 7B depicts a cross-sectional view similar to FIG. 7A, with the plug rotated to a closed state;

FIG. 8 depicts a flowchart of an exemplary method of injection molding the sleeve of FIG. 2 onto the cartridge of FIG. 2;

FIG. 9 depicts a cross-sectional view of another exemplary sleeved plug valve;

FIG. 10 depicts a cross-sectional view of another exemplary sleeved plug valve; and

FIG. 11 depicts a perspective view of a cartridge of the sleeved plug valve of FIG. 10.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

I. First Exemplary Sleeved Plug Valve

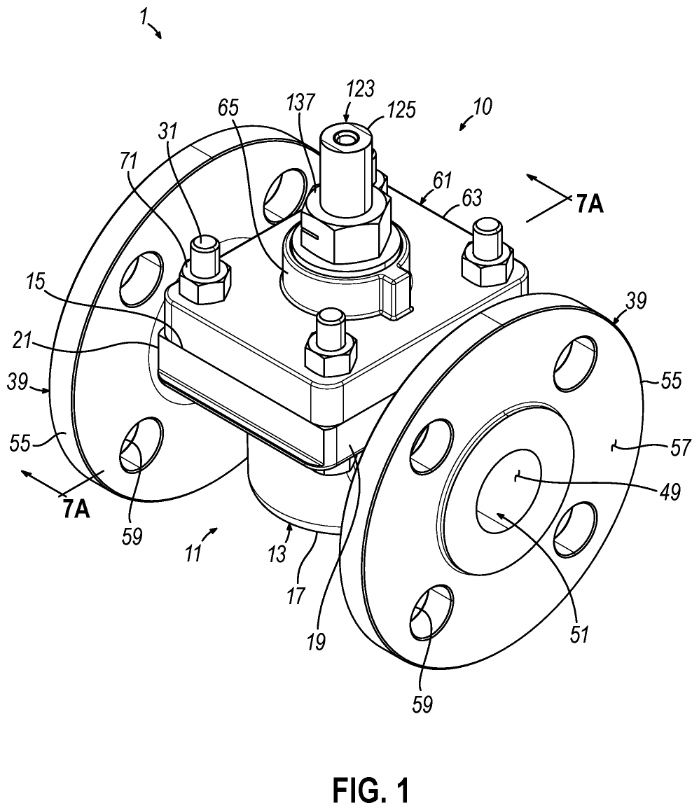

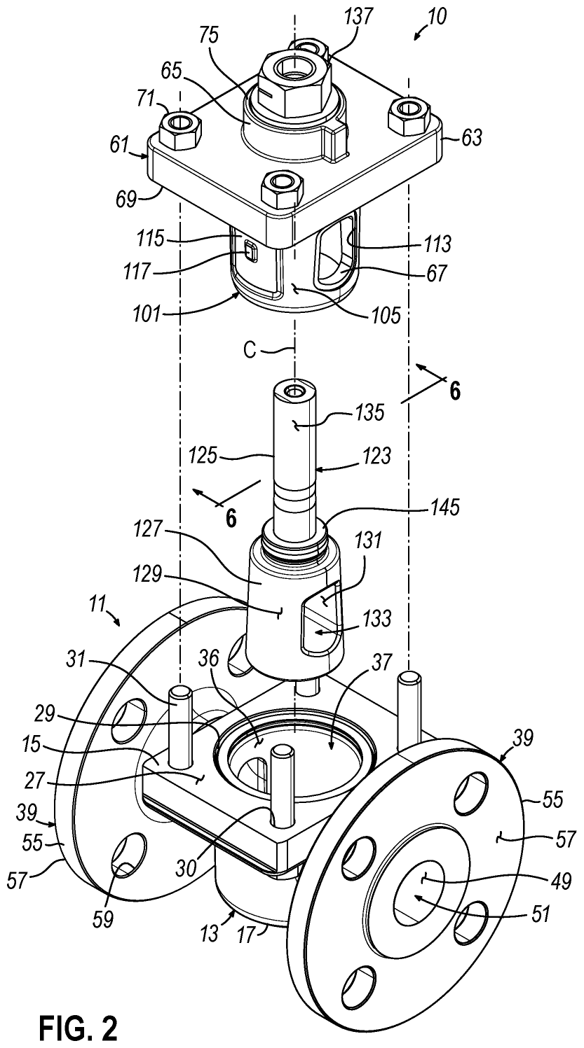

A first sleeved plug valve is shown in FIGS. 1 and 2, hereinafter referred to as valve (1). In the example shown, valve (1) includes a sleeved plug style valve assembly (10) and a main valve body (11) configured to receive valve assembly (10). As will be discussed in greater detail below, valve (1) may provide various benefits relative to prior art valves.

A. Exemplary Valve Body

Valve body (11) of valve (1) may be modular with bimetallic option. As used herein, the phrase “bimetallic option” denotes how elements or features of modular valve body (11) may be comprised of similar materials or optionally may be comprised of different materials. Modular valve body (11) may also be referred to as a hybrid valve body given the two different materials used in its construction in some versions. In some versions, modular valve body (11) may be configured in accordance with at least some of the teachings of U.S. Pat. App. No. 62/937,869, entitled “Modular Valve Body with Bimetallic Option,” filed Nov. 20, 2019, the disclosure of which is incorporated by reference in its entirety.

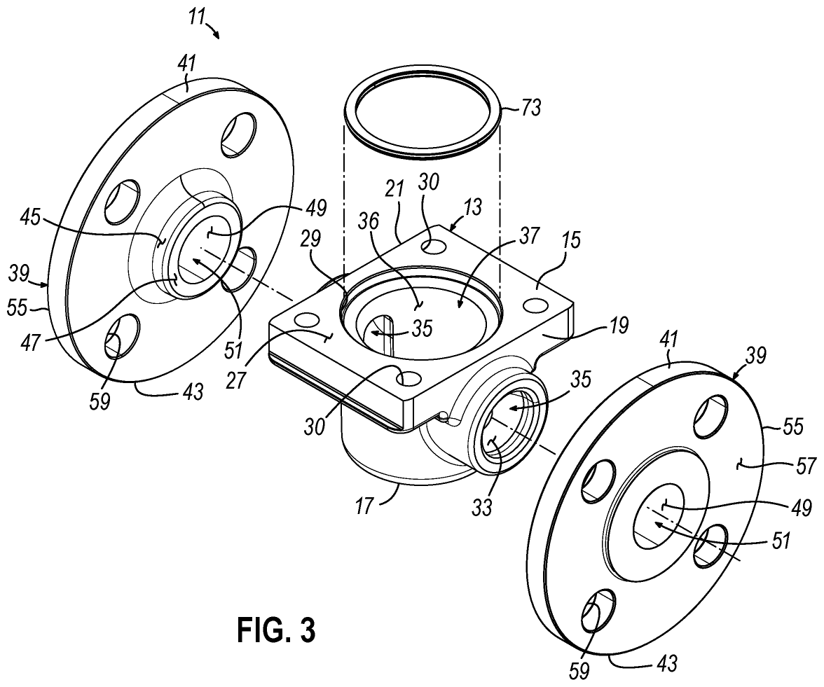

As best shown in FIGS. 2 and 3, modular valve body (11) includes a housing (13) which includes a top (15) and a bottom (17), as well as a first side (19) and a spaced apart second side (21). Top (15) includes a top surface (27). A recess (29) is defined in top surface (27) and sized and positioned to selectively receive a portion of valve assembly (10), as discussed in greater detail below. Top (15) defines a plurality of top bores (30) extending from top surface (27) through top (15). Top bores (30) are each sized and positioned to receive a respective bolt or similar connector or fastener (31) therethrough.

Housing (13) also includes a pair of generally cylindrical, opposed internal housing surfaces (33) (one shown). Internal housing surfaces (33) define respective housing flow passages (35) to facilitate the flow of fluid through housing (13). Housing (13) also includes a generally cylindrical, central internal housing surface (36) which defines an internal chamber (37) sized to receive a portion of valve assembly (10) therein for selectively restricting the flow of fluid through housing (13), as described in greater detail below. Internal chamber (37) may define a central axis (C) of valve (1) and housing flow passages (35) may extend transversely relative to internal chamber (37), and thus relative to central axis (C).

Modular valve body (11) also includes at least one end connector element (39). When modular valve body (11) is fully assembled, end connector element (39) extends from housing (13). End connector element (39) is generally cylindrical and extends from a top (41) to a bottom (43) and includes a peripheral surface (45) and an external surface (47). End connector element (39) includes a generally cylindrical, internal end surface (49). Internal end surface (49) defines an end flow passage (51) to facilitate the flow of fluid through end connector element (39). When joined with housing (13), end flow passage (51) is in fluid communication with housing flow passage (35). End connector element (39) is configured to be joined with a pipeline to secure the pipeline to modular valve body (11). End connector element (39) further includes a connector flange (55) extending outwardly away from peripheral surface (45). Connector flange (55) includes an outward surface (57) for abutting with a similar flange on a pipeline (not shown). Connector flange (55) defines a plurality of connector bores (59) extending from outward surface (57) through connector flange (55). Connector bores (59) are each sized and positioned to receive a respective bolt or similar connector or fastener (not shown) therethrough. The connector may be passed through a similar connector flange on the pipeline to connect the pipeline to end connector element (39).

As shown, housing (13) and end connector element (39) are joined together to form modular valve body (11). In some versions of modular valve body (11), end connector element (39) is joined to housing (13) by inertial friction welding end connector element (39) onto housing (13), as described in U.S. Pat. App. No. 62/937,869. While valve body (11) has been described as being modular with housing (13) and end connector elements (39) initially formed separately from each other as individual pieces and subsequently joined to each other, valve body (11) may alternatively be unitary, with housing (13) and end connector elements (39) integrally formed (e.g., cast) together as a single piece.

B. Exemplary Valve Assembly

With continuing reference primarily to FIG. 2, valve assembly (10) of valve (1) includes a cartridge (61) having a generally rectangular mounting plate (63) configured to be removably coupled to top (15) of housing (3), a generally cylindrical central upper hub (65) extending upwardly from mounting plate (63), and a generally tubular central lower hub (67) extending downwardly from mounting plate (63) and configured to be received within internal chamber (37) of housing (3) when mounting plate (63) is fixedly coupled to top (15). In this regard, mounting plate (63) includes a lower surface (69) for abutting or otherwise confronting top surface (27) of top (15). Mounting plate (63) defines a plurality of mounting plate bores (not shown) extending from lower surface (69) through mounting plate (63), each of which are each sized and positioned to receive a respective bolt or similar connector or fastener (31) therethrough to thereby fixedly couple mounting plate (63) to top (15) (e.g., via corresponding nuts (71)) while permitting selective removal of mounting plate (63) from top (15). In the example shown, valve assembly (10) also includes an annular gasket (73) (FIG. 3) having a generally undulated cross section and positioned at or below lower surface (69) such that gasket (73) is configured to be received within and sealingly engage recess (77) of housing (13) to provide a fluid-tight seal therebetween.

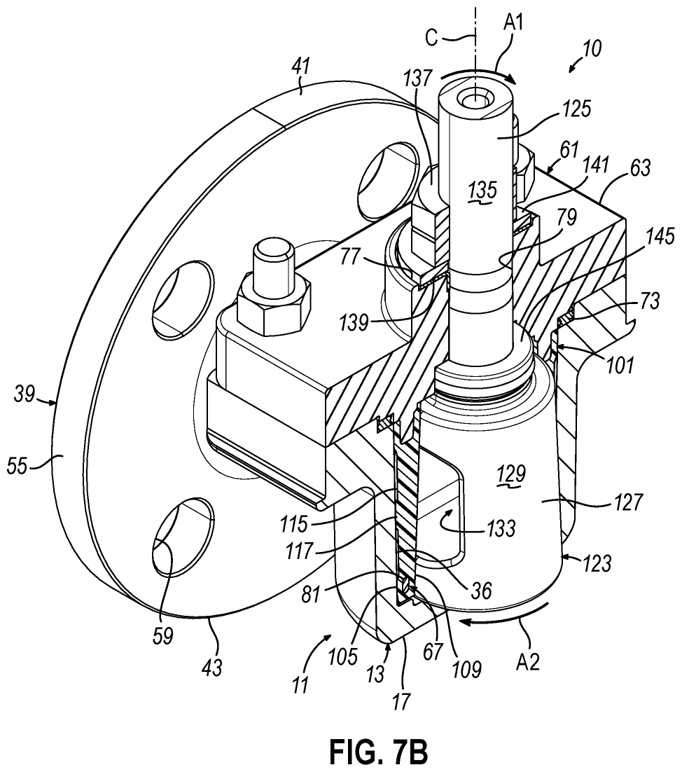

Upper hub (65) includes a generally annular upper surface (75) in which a recess (77) (FIG. 7A) is defined, the purpose of which is discussed below. Mounting plate (63) and upper hub (65) collectively define a central bore (79) (FIG. 7A) extending from lower surface (69) through mounting plate (63) and upper hub (65) to recess (77), and configured to be axially aligned with internal chamber (37) of housing (3). Central bore (79) may be single-stage such that central bore (79) has a constant diameter, or may be multi-stage such that central bore (79) has a plurality of diameters.

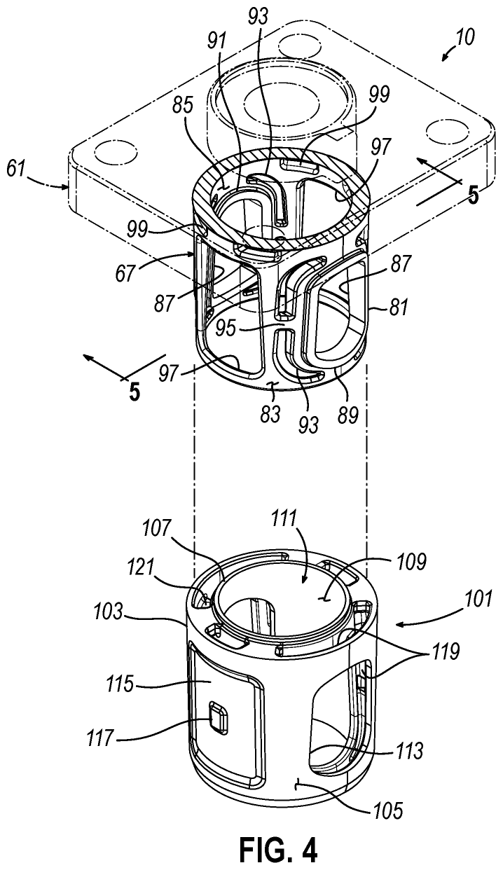

As best shown in FIG. 4, lower hub (67) includes a support frame (81) having a generally cylindrical external lower hub surface (83) and a generally frustoconical internal lower hub surface (85) tapering radially outwardly in a downward direction (e.g., at an angle (α) relative to central axis (C) as described below) such that relatively lower portions of lower hub (67) have a relatively greater internal cross dimension than relatively upper portions of lower hub (67). Lower hub (67) defines a pair of opposed lower hub apertures (87) extending from external lower hub surface (83) to internal lower hub surface (85) and configured to be aligned with respective housing flow passages (35) of housing (13). As shown, lower hub (67) includes a pair of opposed external rims (89) extending outwardly from external lower hub surface (83) about the peripheries of respective lower hub apertures (87) and a pair of opposed internal rims (91) extending inwardly from internal lower hub surface (85) about the peripheries of respective lower hub apertures (87).

Support frame (81) defines a plurality of curved slots (93) extending from external lower hub surface (83) to internal lower hub surface (85) partially about the peripheries of respective lower hub apertures (87). In the example shown, four curved slots (93) are arranged about each lower hub aperture (87), with each adjacent pair of curved slots (93) separated from each other by a support rib (95) of support frame (81). Support frame (81) also defines a pair of opposed openings (97) extending from external lower hub surface (83) to internal lower hub surface (85) between lower hub apertures (87) and their corresponding curved slots (93). Support frame (81) further defines a plurality of straight slots (99) extending from external lower hub surface (83) to internal lower hub surface (85) generally above respective openings (97). In the example shown, two straight slots (99) are arranged above each opening (97). As discussed in greater detail below, curved slots (93), openings (97), and straight slots (99) may each be configured to assist in securing another material to support frame.

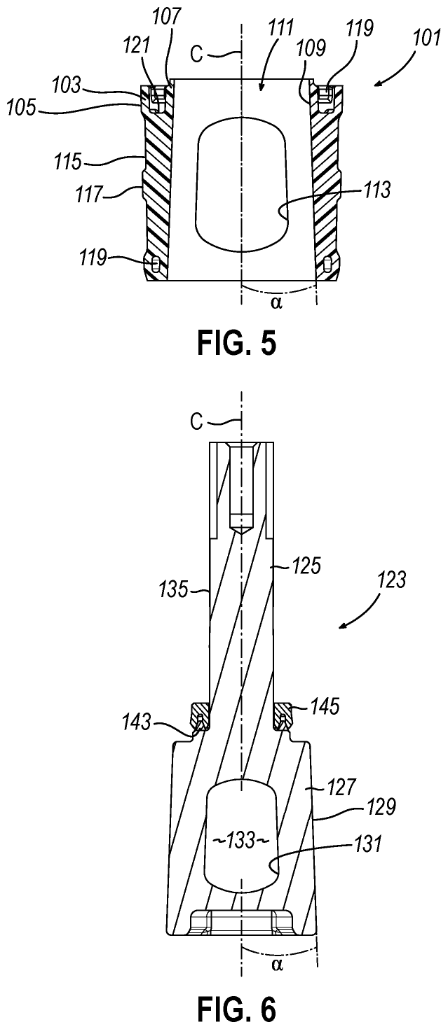

In this regard, valve assembly (10) also includes a sleeve (101) fixedly coupled to lower hub (67) of cartridge (61). As best shown in FIGS. 4 and 5, sleeve (101) includes an outer sleeve portion (103) configured to overlie external lower hub surface (83) and having a generally cylindrical external sleeve surface (105) for frictionally and/or sealingly engaging central internal housing surface (36) to inhibit relative movement therebetween and/or to provide a fluid-tight seal therebetween, and an inner sleeve portion (107) configured to overlie internal lower hub surface (85) and having a generally frustoconical internal sleeve surface (109) tapering radially outwardly in a downward direction at angle (α) relative to central axis (C) such that relatively lower portions of sleeve (101) have a relatively greater internal cross dimension than relatively upper portions of sleeve (101). Internal sleeve surface (109) defines an interior cavity (111) configured to communicate with central bore (79). Sleeve (101) defines a pair of opposed sleeve apertures (113) extending from external sleeve surface (105) to internal sleeve surface (109) in alignment with lower hub apertures (87). In this regard, sleeve apertures (113) may substantially surround respective rims (89, 91) of lower hub (67). A pair of opposed recesses (115) are defined in external sleeve surface (105) between sleeve apertures (113), and a pair of opposed protrusions (117) extend outwardly from respective recesses (115) for frictionally engaging central internal housing surface (36) to inhibit relative movement therebetween. For example, protrusions (117) may extend radially outwardly away from central axis (C) beyond external sleeve surface (105). In any event, outer and inner sleeve portions (103, 107) are spaced apart from each other by various channels (119) configured to receive respective portions of support frame (81) (e.g., support ribs (95)) and are coupled to each other by various connecting portions (121) configured to occupy respective slots (93, 99) and/or openings (97) of support frame (81) such that support frame (81) may be securely captured between inner and outer sleeve portions (103, 107). Thus, sleeve (101) may at least partially encapsulate lower hub (67) while providing access to lower hub apertures (87) via sleeve apertures (113).

In some versions, sleeve (101) may be constructed of a polymeric material having a relatively high chemical resistance and a relatively low coefficient of friction, such as PTFE or any other suitable polymer. In addition or alternatively, support frame (81) may be constructed of a metallic material to provide substantial structural stability to sleeve (101). In some versions, cartridge (61) may be unitary, with mounting plate (63), upper hub (65), and lower hub (67) (including support frame (81)) integrally formed (e.g., cast) together as a single piece.

Valve assembly (10) further includes a plug (123) rotatably coupled to mounting plate (63) and extending downwardly therefrom into interior cavity (111) of sleeve (101) such that plug (123) is configured to be received together with lower hub (67) and sleeve (101) within internal chamber (37) of housing (3). In this regard, plug (123) includes an input shaft (125) configured to be axially aligned with and rotatably received by central bore (79) of cartridge (61) and a plug body (127) extending downwardly from input shaft (125) such that plug body (127) may be rotatable within interior cavity (111) of sleeve (101) about central axis (C) relative to sleeve (101).

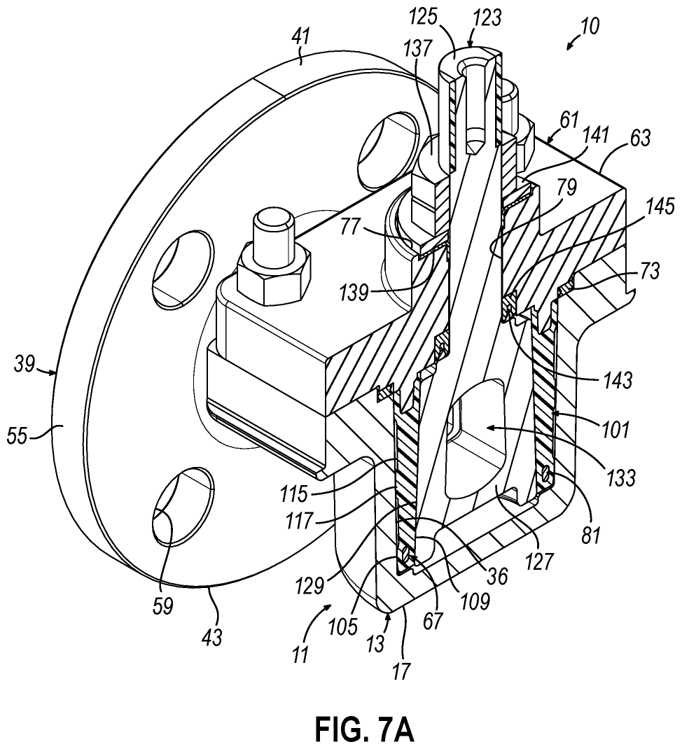

As best shown in FIG. 6, plug body (127) has a generally frustoconical external plug surface (129) tapering radially outwardly in a downward direction at angle (α) relative to central axis (C) such that relatively lower portions of plug body (127) have a relatively greater external cross dimension than relatively upper portions of plug body (127). In this regard, plug body (127) may have a varying external cross dimension corresponding to the varying internal cross dimension of sleeve (101). In this manner, external plug surface (129) is complementary to internal sleeve surface (109) such that external plug surface (129) is configured to mate with and sealingly engage internal sleeve surface (109) to provide a fluid-tight seal therebetween. Plug (123) includes an internal plug surface (131) extending transversely through plug body (127) between opposing portions of external plug surface (129). Internal plug surface (131) defines a plug flow passage (133) for selectively aligning with apertures (87, 113) of lower hub (67) and sleeve (101) to facilitate selective flow of fluid therethrough.

In some versions, plug (123) may be translatable relative to sleeve (101) along central axis (C) for adjusting a height of plug (123) relative to sleeve (101). In this regard, input shaft (125) of the present example has a generally cylindrical external shaft surface (135) which may have at least one helical shaft thread (not shown) defined at least partially therealong, and valve assembly (10) of the present example further includes a height adjustment nut (137) configured to threadably engage external shaft surface (135) of input shaft (125). Nut (137) may be configured to remain at a fixed height relative to cartridge (61) and housing (13) when mounting plate (63) is fixedly coupled to top (15). In the example shown, nut (137) is positioned above upper hub (65). More particularly, valve assembly (10) further includes an annular gasket (139) (FIG. 7A) having a generally L-shaped cross-section and received within recess (77) and an annular washer (141) sandwiched between nut (137) and gasket (139) such that nut (137) is vertically supported above upper hub (65) by gasket (139) and/or washer (141). Thus, nut (137) may be configured to remain at the illustrated height via gravity, at least when valve (1) is in an upright position. It will be appreciated that any other suitable means for maintaining nut (137) at a fixed height may be used. In this manner, rotation of nut (137) relative to input shaft (125) may cause input shaft (125) to translate relative to nut (137) along central axis (C), such that plug (123) may likewise translate relative to sleeve (101) along central axis (C).

Valve assembly (10) of the present example also includes an annular gasket (143) having a generally wedge-shaped cross section and positioned atop plug body (127) and a corresponding annular gasket (145) having a generally fork-shaped cross section and positioned within central bore (79) of cartridge (61) for sealingly engaging each other to provide a fluid-tight seal therebetween while accommodating relative movement therebetween due to height adjustments of plug (123) relative to sleeve (101) as well as rotation of plug (123) relative to sleeve (101).

C. Exemplary Actuation of Valve

Referring now primarily to FIGS. 7A-7B, valve (1) may be actuatable via rotation of plug (123) about central axis (C) relative to sleeve (101) between an open state (FIG. 7A) and a closed state (FIG. 7B). Such rotation of plug (123) about central axis (C) relative to sleeve (101) for actuating valve (1) may be achieved via application of an input torque to input shaft (125) of plug (123), as indicated by first and second arrows (A1, A2) in FIG. 7B.

When plug (123) is in the open state shown in FIG. 7A, plug flow passage (133) is aligned with apertures (87, 113) of lower hub (67) and sleeve (101) such that housing flow passages (35) may fluidly communicate with each other via plug flow passage (133). Thus, fluid may flow from one of housing flow passages (35) to the other of housing flow passages (35) through plug flow passage (133) when plug (123) is in the open state. When plug (123) is in the closed state shown in FIG. 7B, plug flow passage (133) is substantially misaligned from (e.g., oriented perpendicularly relative to) apertures (87, 113) of lower hub (67) and sleeve (101) such that housing flow passages (35) may be fluidly isolated from each other via plug body (127). Thus, fluid may be blocked from flowing from one of housing flow passages (35) to the other of housing flow passages (35) by plug body (127) when plug (123) is in the closed state.

It will be appreciated that in some versions, plug (123) may be rotatable about central axis (C) relative to sleeve (101) to one or more intermediate states between the open and closed states (e.g., to one or more “partially open” or “partially closed” states), whereby plug flow passage (133) is only slightly misaligned from apertures (87, 113) of lower hub (67) and sleeve (101) such that housing flow passages (35) may fluidly communicate with each other via plug flow passage (133). In such cases, the slight misalignment of plug flow passage (133) from apertures (87, 113) of lower hub (67) and sleeve (101) may provide a fluid constriction for fluid flowing from one of housing flow passages (35) to the other of housing flow passages (35) through plug flow passage (133).

D. Exemplary Molding of Sleeve onto Cartridge

Sleeve (101) may be injection molded over support frame (81) to thereby fixedly couple sleeve (101) to lower hub (67) of cartridge (61). In this regard, curved slots (93), openings (97), and straight slots (99) of support frame (81) may each be configured to receive a molten material, such as during an injection molding process, to assist in securing such material to support frame (81) as the material cools to form sleeve (101).

To this end, sleeve (101) may be constructed of a fluoropolymeric material, such as PTFE, perfluoroalkoxy alkanes (PFA), fluorinated ethylene propylene (FEP), polyvinylidene difluoride (PVDF), or fluorocarbon (FKM/FFKM). Other exemplary materials which may be used to construct sleeve (101) may include thermoplastic polyamides (PI) and polyether ether ketone (PEEK). Such materials may provide a relatively high chemical resistance and a relatively low coefficient of friction, as well as melt processability, to thereby facilitate injection molding of the material for forming sleeve (101). Such materials may further have a relatively high temperature resistance, such as up to about 500° F.

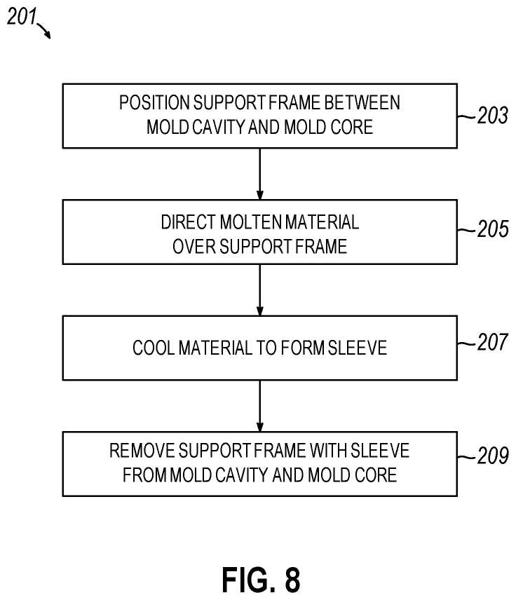

An exemplary method (201) of injection molding sleeve (101) over support frame (81) is depicted as a flowchart in FIG. 8. Method (201) begins with a step (203), whereby support frame (81) is positioned between a mold cavity (not shown) configured to form the external features of sleeve (101) (e.g., external sleeve surface (105)) and a mold core (not shown) configured to form the internal features of sleeve (101) (e.g., internal sleeve surface (109)). Thereafter, step (203) proceeds to step (205). In step (205), a molten material (e.g., a fluoropolymer) is directed onto support frame (81) over external and internal hub surfaces (83, 85) and into slots (93, 99) and openings (97). Thereafter, step (205) proceeds to step (207). In step (207), the material cools to thereby form sleeve (101) over and secured to support frame (81). Thereafter, step (207) proceeds to step (209), whereby support frame (81), together with the formed sleeve (101), is removed from the mold cavity and mold core.

II. Second Exemplary Sleeved Plug Valve

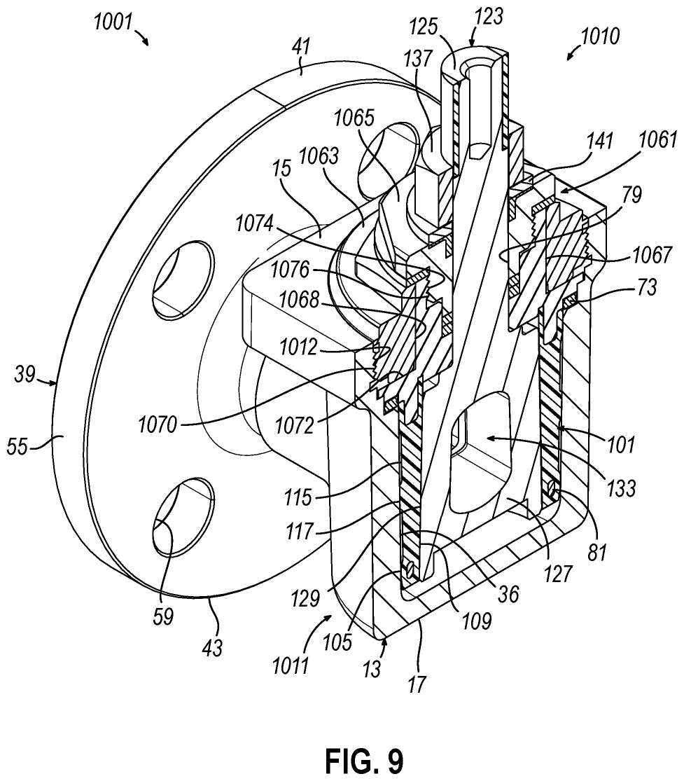

A second sleeved plug valve is shown in FIG. 9, hereinafter referred to as valve (1001). In the example shown, valve (1001) includes a sleeved plug style valve assembly (1010) and a main valve body (1011) configured to receive valve assembly (1010). Valve (1001) is similar to valve (1) described above except as otherwise described below.

Main valve body (1011) of the present version is generally similar to valve body (11) described above, but further includes a threaded bore (1012) coaxial with and above internal chamber (37), the purpose of which is described below.

Valve assembly (1010) of the present version is generally similar to valve assembly (10) described above, but replaces cartridge (61) with a different cartridge (1061). As shown, rather than having mounting plate (63), upper hub (65), and lower hub (67) that are integrally formed together as a unitary piece like cartridge (61), cartridge (1061) of the present version is a multi-piece construction. More particularly, cartridge (1061) includes a mounting collar (1063), an upper hub (1065), and a lower hub (1067) separately formed from each other as distinct pieces. Mounting collar (1063), upper hub (1065), and lower hub (1067) are generally similar to mounting plate (63), upper hub (65), and lower hub (67) described above, respectively, except as described below.

In the present version, mounting collar (1063) is generally annular such that mounting collar (1063) defines a central opening (1068) configured to selectively receive lower hub (1067). Mounting collar (1063) also defines a threaded exterior (1070) configured to threadably engage threaded bore (1012) to thereby fixedly couple mounting collar (1063) to top (15) while permitting selective removal of mounting collar (1063) from top (15). In this manner, mounting collar (1063) may selectively secure lower hub (1067) within internal chamber (37) of housing (3). Lower hub (1067) includes an upwardly-facing ledge (1072) configured to abut a lower surface of mounting collar (1063) when lower hub (1067) is positioned within internal chamber (37) of housing (3) and mounting collar (1063) is coupled to top (15) for assisting with preventing lower hub (1067) from being inadvertently dislodged from internal chamber (37). Lower hub (1067) also includes a threaded bore (1074) configured to threadably engage a portion of upper hub (1065) to thereby fixedly couple upper hub (1065) to lower hub (1067) while permitting selective removal of upper hub (1065) from lower hub (1067). To that end, upper hub (1065) includes a threaded exterior (1076) configured to threadably engage threaded bore (1074) of lower hub (1067).

III. Third Exemplary Sleeved Plug Valve

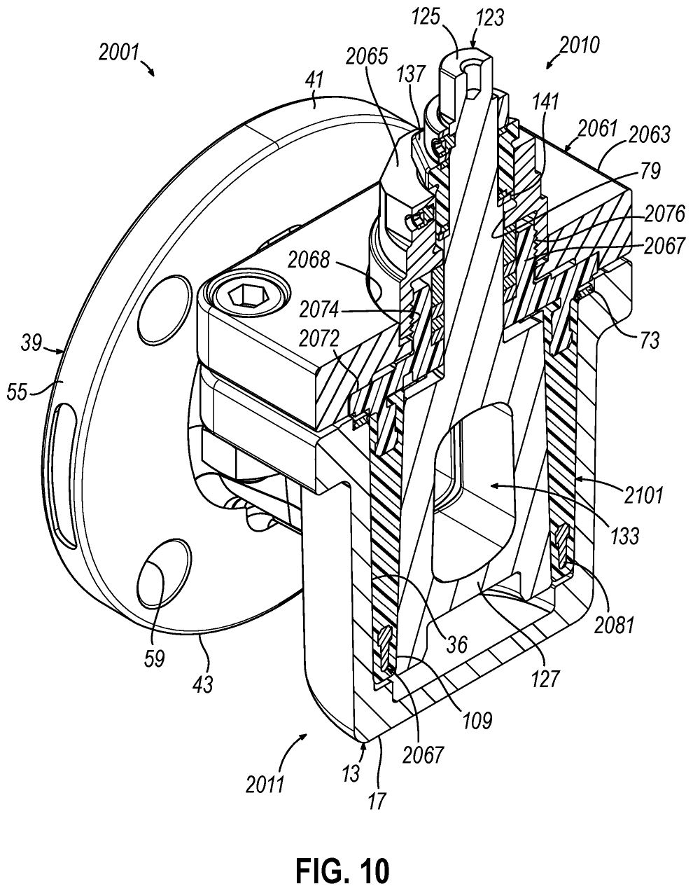

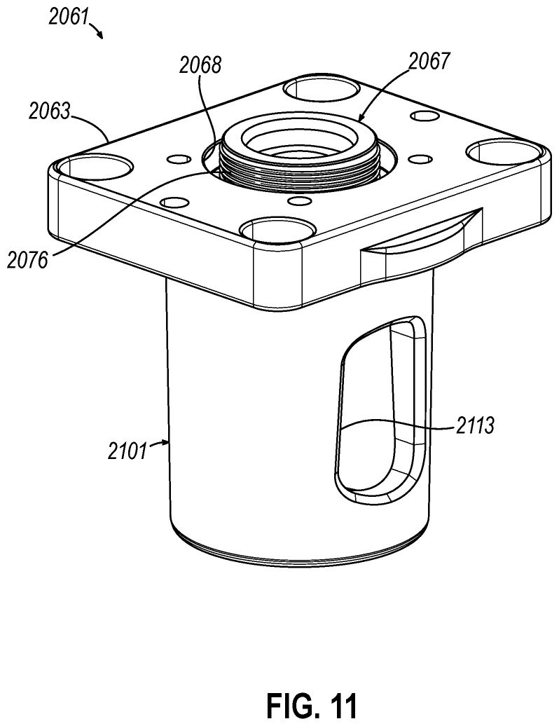

A third sleeved plug valve is shown in FIGS. 10-11, hereinafter referred to as valve (2001). In the example shown, valve (2001) includes a sleeved plug style valve assembly (2010) and a main valve body (2011) configured to receive valve assembly (2010). Valve (2001) is similar to valve (1) described above except as otherwise described below.

Main valve body (2011) of the present version is generally similar to valve body (11) described above. Valve assembly (2010) of the present version is generally similar to valve assembly (10) described above, but replaces cartridge (61) with a different cartridge (2061). As shown, rather than having mounting plate (63), upper hub (65), and lower hub (67) that are integrally formed together as a unitary piece like cartridge (61), cartridge (2061) of the present version is a multi-piece construction. More particularly, cartridge (2061) includes a mounting plate (2063), an upper hub (2065), and a lower hub (2067) separately formed from each other as distinct pieces. Mounting plate (2063), upper hub (2065), and lower hub (2067) are generally similar to mounting plate (63), upper hub (65), and lower hub (67) described above, respectively, except as described below.

In the present version, mounting plate (2063) defines a central opening (2068) configured to selectively receive portions of upper and lower hubs (2065, 2067). Lower hub (2067) includes an upwardly-facing ledge (2072) configured to abut a lower surface of mounting plate (2063) when lower hub (2067) is positioned within internal chamber (37) of housing (3) and mounting plate (2063) is coupled to top (15) for assisting with preventing lower hub (2067) from being inadvertently dislodged from internal chamber (37). Upper hub (2065) includes a threaded bore (2074) configured to threadably engage a portion of lower hub (2067) to thereby fixedly couple upper hub (2065) to lower hub (2067) while permitting selective removal of upper hub (2065) from lower hub (2067). To that end, lower hub (2067) includes a threaded exterior (2076) configured to threadably engage threaded bore (2074) of upper hub (2065).

As shown, rather than leaving portions of a support frame (2081) of lower hub (2067) exposed (like the inner peripheries of rims (89, 91) of lower hub (67)), a sleeve (2101) may substantially entirely encapsulate support frame (2081). For example, sleeve apertures (2113) may cover the inner peripheries of the rims of lower hub apertures (not shown) of lower hub (2067) to more fully encapsulate support frame (2081).

IV. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### EXAMPLE 1

A valve assembly comprising: (a) a cartridge configured to be removably coupled to a valve body and including a hub; and (b) a sleeve encapsulating at least a portion of the hub and having an internal sleeve surface defining an interior cavity.

### EXAMPLE 2

The valve assembly of any of the previous or subsequent Examples, further comprising a plug positioned within the interior cavity and including a plug body having an external plug surface configured to sealingly engage the internal sleeve surface.

### EXAMPLE 3

The valve assembly of any of the previous or subsequent Examples, wherein the hub includes an internal hub surface, wherein the internal sleeve surface overlies the internal hub surface.

### EXAMPLE 4

The valve assembly of any of the previous or subsequent Examples, wherein the hub includes an external hub surface, wherein the sleeve has an external sleeve surface overlying the external hub surface.

### EXAMPLE 5

The valve assembly of any of the previous or subsequent Examples, wherein the hub includes a pair of opposed hub apertures extending between the internal and external hub surfaces, wherein the sleeve includes a pair of opposed sleeve apertures aligned with the pair of opposed hub apertures.

### EXAMPLE 6

The valve assembly of any of the previous or subsequent Examples, wherein the hub includes a pair of opposed internal rims extending inwardly from internal hub surface about peripheries of respective hub apertures.

### EXAMPLE 7

The valve assembly of any of the previous or subsequent Examples, wherein the hub includes a pair of opposed external rims extending outwardly from external hub surface about peripheries of respective hub apertures.

### EXAMPLE 8

The valve assembly of any of the previous or subsequent Examples, wherein the hub includes a support frame, wherein the sleeve encapsulates the support frame.

### EXAMPLE 9

The valve assembly of any of the previous or subsequent Examples, wherein the sleeve includes an outer sleeve portion and an inner sleeve portion at least partially spaced apart from the outer sleeve portion, wherein the internal sleeve surface is presented by the inner sleeve portion, wherein the support frame is captured between the inner and outer sleeve portions.

### EXAMPLE 10

The valve assembly of any of the previous or subsequent Examples, wherein the sleeve includes at least one channel between the inner and outer sleeve portions, wherein the support frame includes at least one support rib received within the at least one channel.

### EXAMPLE 11

The valve assembly of any of the previous or subsequent Examples, wherein the support frame includes at least one slot or opening, wherein the sleeve includes at least one connecting portion extending between the inner and outer sleeve portions through the at least one slot or opening.

### EXAMPLE 12

The valve assembly of any of the previous or subsequent Examples, wherein the sleeve is injection molded onto at least the portion of the hub.

### EXAMPLE 13

The valve assembly of any of the previous or subsequent Examples, wherein the sleeve is constructed of a polymeric material.

### EXAMPLE 14

The valve assembly of any of the previous or subsequent Examples, wherein the sleeve is constructed of at least one of PTFE, PFA, FEP, PVDF, FKM, FFKM, PI, or PEEK.

### EXAMPLE 15

The valve assembly of any of the previous or subsequent Examples, wherein the cartridge is constructed of a metallic material.

### EXAMPLE 16

A method of fixedly securing a sleeve to a cartridge having a support frame, the method comprising: (a) positioning the support frame between a mold cavity and a mold core; (b) directing molten material over the support frame; (c) cooling the molten material to thereby form the sleeve; and (d) removing the support frame with the sleeve from the mold cavity and the mold core.

### EXAMPLE 17

The method of any of the previous or subsequent Examples, wherein the molten material includes a fluoropolymer.

### EXAMPLE 18

A valve assembly comprising: (a) a cartridge including (i) a mounting portion configured to be removably coupled to a valve body, and (ii) a hub portion extending downwardly from the mounting portion; and (b) a sleeve at least partially encapsulating the hub portion and having an internal sleeve surface defining an interior cavity.

### EXAMPLE 19

The valve assembly of any of the previous or subsequent Examples, wherein the mounting portion and the hub portion are integrally formed together as a unitary piece.

### EXAMPLE 20

The valve assembly of claim 18, wherein the mounting portion and the hub portion are separately formed from each other as distinct pieces.

V. Miscellaneous

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Any one or more of the teachings, expressions, embodiments, examples, etc. described herein may be combined with any one or more of the teachings, expressions, embodiments, examples, etc. described in U.S. Pat. App. No. 63/119,330, entitled “Torque Reduction Valve Having Separate Static Seal and Dynamic Seal,” filed Nov. 30, 2020; and/or U.S. Pat. App. No. 63/119,339, entitled “Sleeved Plug Valve With Removable Cartridge and Modular Option For Valve Body,” filed Nov. 30, 2020. The disclosure of each of these applications is incorporated by reference herein.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/we claim:

1. A valve assembly comprising:
(a) a cartridge configured to be removably coupled to a valve body and including a hub; and
(b) a sleeve encapsulating at least a portion of the hub and having an internal sleeve surface defining an interior cavity.

2. The valve assembly of claim 1, further comprising a plug positioned within the interior cavity and including a plug body having an external plug surface configured to sealingly engage the internal sleeve surface.

3. The valve assembly of claim 1, wherein the hub includes an internal hub surface, wherein the internal sleeve surface overlies the internal hub surface.

4. The valve assembly of claim 3, wherein the hub includes an external hub surface, wherein the sleeve has an external sleeve surface overlying the external hub surface.

5. The valve assembly of claim 4, wherein the hub includes a pair of opposed hub apertures extending between the internal and external hub surfaces, wherein the sleeve includes a pair of opposed sleeve apertures aligned with the pair of opposed hub apertures.

6. The valve assembly of claim 5, wherein the hub includes a pair of opposed internal rims extending inwardly from internal hub surface about peripheries of respective hub apertures.

7. The valve assembly of claim 5, wherein the hub includes a pair of opposed external rims extending outwardly from external hub surface about peripheries of respective hub apertures.

8. The valve assembly of claim 1, wherein the hub includes a support frame, wherein the sleeve encapsulates the support frame.

9. The valve assembly of claim 8, wherein the sleeve includes an outer sleeve portion and an inner sleeve portion at least partially spaced apart from the outer sleeve portion, wherein the internal sleeve surface is presented by the inner sleeve portion, wherein the support frame is captured between the inner and outer sleeve portions.

10. The valve assembly of claim 9, wherein the sleeve includes at least one channel between the inner and outer sleeve portions, wherein the support frame includes at least one support rib received within the at least one channel.

11. The valve assembly of claim 9, wherein the support frame includes at least one slot or opening, wherein the sleeve includes at least one connecting portion extending between the inner and outer sleeve portions through the at least one slot or opening.

12. The valve assembly of claim 1, wherein the sleeve is injection molded onto at least the portion of the hub.

13. The valve assembly of claim 1, wherein the sleeve is constructed of a polymeric material.

14. The valve assembly of claim 13, wherein the sleeve is constructed of at least one of PTFE, PFA, FEP, PVDF, FKM, FFKM, PI, or PEEK.

15. The valve assembly of claim 1, wherein the cartridge is constructed of a metallic material.

16. A method of fixedly securing a sleeve to a cartridge having a support frame, the method comprising:
(a) positioning the support frame between a mold cavity and a mold core;
(b) directing molten material over the support frame;
(c) cooling the molten material to thereby form the sleeve; and
(d) removing the support frame with the sleeve from the mold cavity and the mold core.

17. The method of claim 16, wherein the molten material includes a fluoropolymer.

18. A valve assembly comprising:
(a) a cartridge including:
(i) a mounting portion configured to be removably coupled to a valve body, and
(ii) a hub portion extending downwardly from the mounting portion; and
(b) a sleeve at least partially encapsulating the hub portion and having an internal sleeve surface defining an interior cavity.

19. The valve assembly of claim 18, wherein the mounting portion and the hub portion are integrally formed together as a unitary piece.

20. The valve assembly of claim 18, wherein the mounting portion and the hub portion are separately formed from each other as distinct pieces.
